(19) United States
(12) Patent Application Publication
(10) Pub. No.: US 2017/0181205 A1
(43) Pub. Date: Jun. 22, 2017

(54) DIRECT CONNECTION NETWORK

(71) Applicant: Intel Corporation, Santa Clara, CA (US)

(72) Inventors: Ravindra Hegde, Bangalore (IN); Singaravelan Nallasellan, Bangalore (IN); Dharmendra Muthuswamy, Bangalore (IN)

(73) Assignee: Intel Corporation, Santa Clara, CA (US)

(21) Appl. No.: 14/976,520

(22) Filed: Dec. 21, 2015

(51) Int. Cl. H04W 76/02; H04L 9/08; H04L 29/06; H04W 12/06; H04W 12/04

(52) U.S. Cl. CPC H04W 76/023; H04W 12/06; H04W 12/04; H04L 63/08; H04L 63/0428; H04L 9/0819

(57) ABSTRACT

A broadcast system and method for a direct connection network or personalized network, including a presenter computing device configured for a wireless direct connection with multiple receiving computing devices and to broadcast content via the wireless direct connection to the multiple receiving devices. The multiple receiving computing devices are configured for the wireless direct connection with the presenter computing device and to receive via the wireless direct connection the content broadcast by the presenter computing device. A server computing device is configured to authenticate the multiple receiving devices.

### TECHNICAL FIELD

The present techniques relate generally to networking and communicating, and more particularly, to a wireless direct connection network or a personalized network that may accommodate broadcasting, presentations, and the like.

### BACKGROUND ART

The electronic communication of information among members of an organization, such as among employees of a business, and so on, has become commonplace. There exists an ongoing need to facilitate and improve the reliability, convenience, and experience of the communication. Indeed, the dissemination and sharing of information within a business unit, academic environment, government entity, and so forth, is generally an important aspect of the organization.

### BRIEF DESCRIPTION OF DRAWINGS

FIG. 1A is a diagram of a system for presentation and broadcast via direct connectivity from a presenter device to multiple devices in accordance with embodiments of the present techniques.

FIG. 1B is a diagram of a system of FIG. 1A having a server for authentication in accordance with embodiments of the present techniques.

FIG. 2 is a sequence diagram of a direct connection network in accordance with embodiments of the present techniques.

FIG. 3 is a sequence diagram of a direct connection network in accordance with embodiments of the present techniques.

FIG. 4 is a block flow diagram of a method for a direct connection network in accordance with embodiments of the present techniques.

FIG. 5 is a sequence diagram of a direct connection network or personalized network in accordance with embodiments of the present techniques.

FIG. 6 is a diagram of a system for peer-to-peer sharing in accordance with embodiments of the present techniques.

FIG. 7 is a block diagram depicting an example of a tangible non-transitory, computer-readable medium that can facilitate broadcasting in a direct connection network in accordance with embodiments of the present techniques.

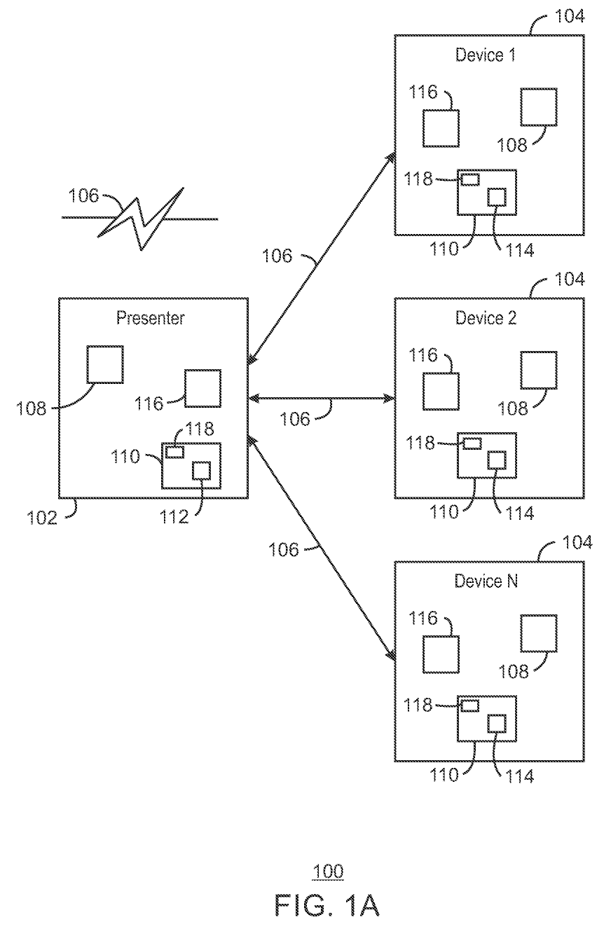

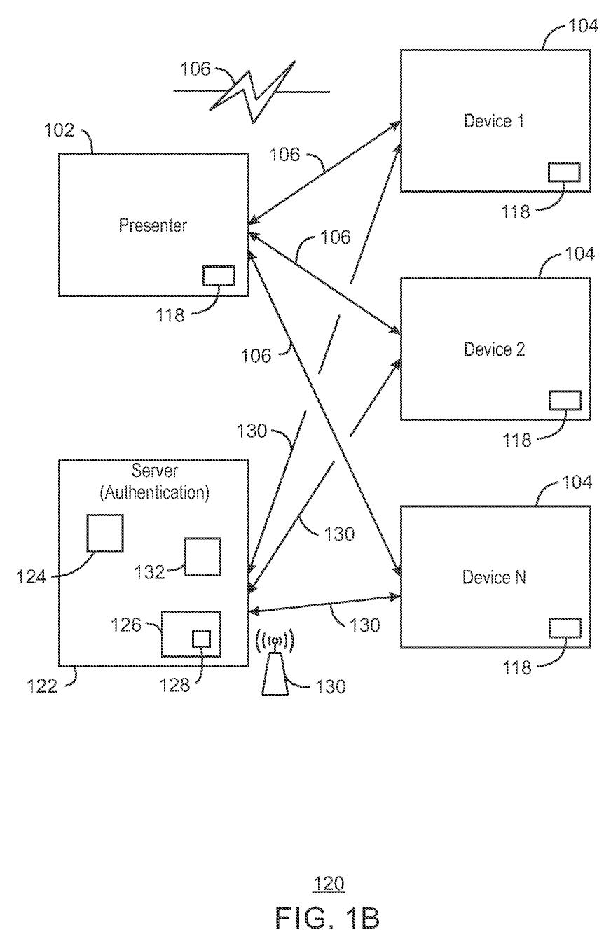

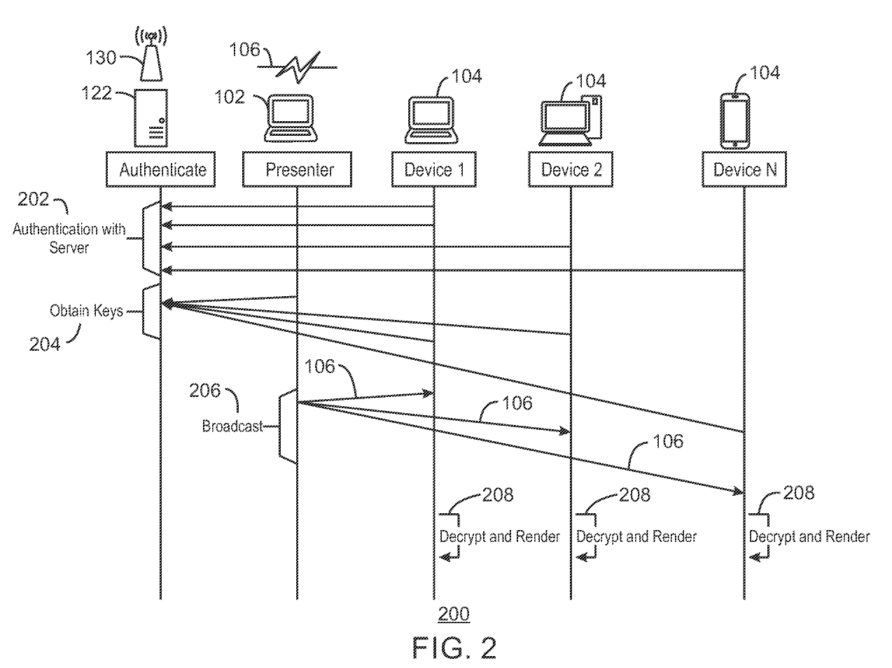

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION

Embodiments of the present techniques include a broadcast system and method for a personalized network, including a presenter computing device configured for a wireless direct connection with multiple receiving computing devices. The presenter computing device to broadcast content via the wireless direct connection to the multiple receiving computing devices. A server computing device may authenticate the multiple receiving devices for decrypting content broadcast by the presenter computing device.

The present techniques relate generally to electronic communication and may involve enterprise usage, electronic networking, peer-to-peer networking, wireless direct communication (e.g., Wi-Fi Direct®, Wi-Fi Miracast™, etc.) between devices, and so forth. Examples may facilitate a personalized network using peer-to-peer for enterprise usage. The technology and techniques may pertain to enterprise communication using localized and/or peer-to-peer networking to reduce latency.

In today's enterprise, Wi-Fi has become a de facto standard for communication. The Wi-Fi may be via a Wi-Fi access point connection. The term Wi-Fi may carry a trademark Wi-Fi®. In a globally connected enterprise, an employee may carry a laptop and use tools such as email, chat, web-meeting software, and the like, to interface with peers across the world and at a given location. However, the latency may be high because packets (data) are routed through a server to the destination address during which multiple hops may be involved. Yet, as recognized herein, the conventional Wi-Fi communication through, for instance, a server can be unnecessary or problematic for certain use cases leading to loss of productivity due to slower connection time and latency in sending and receiving data.

For instance, in a first example, a small group of engineers are discussing a software design in a conference room. They want to share their design diagrams using well known application. However, due to network congestion, latency is experienced while the presentation is being shared. In a second example, a marketing agent wants to quickly send an updated presentation to a peer in the room who is about to make a presentation to larger audience. The marketing agent uses the corporate email to send the presentation. However, due to a slow mail server, the email has still not reached the peer's inbox. In a third example, a group of technicians are attending a live training webcast in a conference room. The content is broadcast to the technicians (trainees) in the conference room. However, due to network congestion and routing, the content is out-of-sync.

Not all usages demand that packets (data) be routed to the destination via the Wi-Fi (AP) network. Often times, enterprise employees are located in close proximity (in-range) such that one or more close-range communication protocol (e.g., Wi-Fi Direct® or variations thereof such as Wi-Fi Miracast™ and the like) can be used to establish a peer-to-peer link, e.g., without going through an access point or server. Exemplary scenarios that may be addressed and improved are: (1) broadcast of meeting web content across a group of members in a meeting room; (2) broadcast of audio-video (AV) content that are time sensitive in nature; (3) peer-to-peer sharing of meeting web content across smaller groups such as in a conference room, and so forth. Embodiments may improve these enterprise issues by providing, for example, creation of a personalized area network using peer-to-peer and/or broadcast-based design by leveraging, enhancing, and combining various communication protocols. Embodiments provide for sharing of content via direct connectivity among groups of people (and their devices) in the enterprise environment, and including with the broadcasting of content via direct connectivity.

The capability to create one-to-one, one-to-many and many-to-many connections for various devices may be provided with devices in range, e.g., in a conference room, cafeteria, etc. Then, an interface for an application to send and receive data on the personal area network may be provided. Such an interface can be leveraged by applications such as web-meeting applications that conventionally route data through Wi-Fi to a central server before the data reaches the target destination. In addition, for use-cases where a user desires to send time-sensitive data or time adjusted data (as in example three above), the embodiments including the software may provide for broadcasting to an audience in range, including timestamping of audio and video packets, time syncing between peers in the audience, and so on.

FIG. 1A is a system 100 for presentation and broadcast via direct connectivity from a presenter computing device 102 to multiple receiving computing devices 104. The system 100 may include a direct connection network, a personalized network, and other features. The devices 102 and 104 may be a desktop computer, a laptop computer, a mobile device (e.g., tablet, smartphone), a wearable computing device such (e.g. computer eyeglasses, smart watch, etc.), and so forth. The presenter device 102 and the multiple devices 104 may be in the same room or within range for direct connectivity. The number of multiple receiving devices 104 may be less than 10 receiving devices 104, and as many as 40 to 50 receiving computing devices 104, or greater than 50. Indeed, increasing standards and bandwidth may accommodate and provide for well over 50 listeners or receiving computing devices 104.

Further, the direct connectivity 106 of the receiving computing devices 104 with the presenter computing device 102 may be a connectivity that is not server-based, and/or does not require an access point (AP), and the like. The direct connectivity 106 may be via Wi-Fi Direct® or Wi-Fi Miracast™, for example. Wi-Fi Direct®, initially called Wi-Fi peer-to-peer (P2P), is a Wi-Fi standard facilitating devices to connect with each other without requiring a wireless access point, and may be usable for internet browsing, file transfer, to communicate with more than one device simultaneously at typical Wi-Fi speeds, and so forth. In general, the embodiments herein with respect to wireless direct connectivity may accommodate broadcasting arrangements, peer-to-peer configurations, and so on.

The receiving computing devices 104, when in range, may wirelessly recognize the presenter device 102 and request to direct connect 106 to the presenter device 102 and/or join the direct connectivity group. In response, the presenter device 102 may accept the direct connection 106 with the given device 104 and, therefore, grant direct connection 106 access of the device 104 to the presenter device 102 or to a direct connectivity group. Moreover, where the presenter device 102 and one or more of the multiple devices 104 are part of a pre-configured direct connectivity group or sub-group, the direct connection 106 between the presenter device 102 and the device 104 may automatically occur when the devices 102 and 104 are within range. Indeed, embodiments may provide for the provisioning of groups or sub-groups that share content via a wireless direct connection 106 such as Wi-Fi Direct®. The members and groups may be specified beforehand and maintained on-going.

The computing devices 102 and 104 may each have a processor 108 and memory 110. The processor 108 may be a hardware processor, a microprocessor, a central processing unit (CPU), and so on. The processor 108 in each device 102 or 104 may be multiple processors and/or the processor 108 may have multiple cores. The memory 110 may include non-volatile memory (hard drive, read-only-memory or ROM, flash memory, cards, etc.), volatile memory (e.g., random access memory or RAM, etc.), firmware, and other types of memory.

The presenter computing device memory 110 may store code 112 (instructions, logic, etc.) executable by the presenter device processor 108 to provide: (1) for direct connectivity 106, (2) to present and/or broadcast information and data to the multiple devices 104, and (3) to implement embodiments discussed herein such as with respect to an underlying software stack, the time-stamping of audio-video content broadcasted, and so on. The broadcasting by the presenting device 102 may involve the presentation of audio-video (AV) content.

The respective memory 110 of the multiple receiving computing devices 104 may have code 114 executable by the respective device processor 108 to provide for direct connectivity 106, and to receive and view information and data presented or broadcast from the presenter device 102, and so on. Furthermore, the receiving computing devices 104 may adjust their clocks and drift according to the broadcast, and the like. Also, the computing devices 104 may receive and store an executable application (e.g., received from the presenter 102, a server, a network, etc.) that executes to provide a broadcast interface and underling software stack. The software or transfer stack may be directed to Bluetooth®, a Wi-Fi access point connection, Wi-Fi Direct®, Wi-Fi Miracast™, near field communication (NFC), wired connections (Ethernet), and so on.

The computing devices 102 and 104 may each have one or more networking hardware 116 to accommodate Wi-Fi, Wi-Fi Direct®, Wi-Fi Miracast™, Bluetooth®, NFC, and wired (e.g., Ethernet) connections and protocols, and other transport platforms, and the like. The multiple computing devices 104 may wirelessly recognize the presenter computing device 102 and make a wireless direct connection 106 (e.g., Wi-Fi Direct®) with the presenter computing device 102.

As mentioned for some examples, a given computing device 104 may request the direct connection 106 with the presenter device 102, and in response, the presenter device 102 may grant the direction connection 106. In other examples, a given computing device 104 may be a member of a pre-configured or predetermined group with the presenter computing device 102. In such cases, the computing device 104 be automatically granted a wireless direction connection 106 with the presenter computing device 102 in response to the devices 102 and 104 being in wireless direct range and recognizing each other. Furthermore, in some examples, the individual receiving devices 104 may direct connect (wirelessly or wired) with each other, and/or through the presenter device 102, and the like.

Moreover, the system 100 (e.g., via the executable code 112 and 114) may provide for a software buffer 118 in memory 110 (e.g., of the multiple receiving devices 104) for the presented or broadcast content. In certain embodiments, the software buffer 118 is a listener's buffer pool and which may be a data layer (e.g., megabytes or greater). Such a software buffer 118 may facilitate broadcasting via the direct connectivity 106 in enterprise usage. The software buffer 118 may be a data layer, an underlying software stack, or part of a software stack, and so forth. In general, in accordance with embodiments, the executable code 112 and 114 may include applications written for the direct connectivity 106 broadcast and that provide an interface for the broadcast. The application(s) may facilitate the sending or broadcasting for the data or content from the presenter computing device 102, and the receiving, processing, and viewing of the data or content at the receiving computing devices.

As indicated, in order to broadcast content for in-range devices, a mechanism is provided for meeting participants to be able to join a “group”. Additionally, authentication of meeting participants may be accommodated, such as using standard security tools in certain examples. In embodiments, the authentication may be by a “server” which could receive requests for authentication from participants via Wi-Fi (access point) or wired connections, for instance. In particular examples, as discussed below, the server may provide the authenticated participants a decrypt key for participants to decrypt the meeting content. In certain embodiments, although the meeting may be broadcast over a shorter range i.e. not using conventional Wi-Fi, the provision of an encryption/decryption methodology may mitigate undesired “eavesdropping”.

FIG. 1B is a system 120 which may be the system 100 of FIG. 1A having a server 122 for authentication of participants and of the multiple devices 104. The server 122 is a computing device having a processor 124 and memory 126 storing code 128 (instructions, logic, etc.) executable by the processor 124 to service authentication. The code 128 may provide for receiving requests for authentication from participants and the multiple computing devices 104, and to process the requests providing authentication or a decryption key(s), for example to the participants and multiple devices 104. As discussed below, the decryption key may be utilized by a participant or device 104 to decrypt content presented or broadcasted from the presenter computing device 102. In the illustrated embodiment, the multiple devices 104 may couple to the server 122 via a Wi-Fi (AP) connection 130 for authentication and obtaining the decryption key. The server 122 may generally have networking hardware 132 and associated software for the Wi-Fi (AP) 130 and other network connections and protocols.

Thus, as indicated with respect to FIG. 1A, the devices 102 and 104 may wirelessly recognize each other and make a Wi-Fi Direct® connection with each other. Also, the devices 104 may access the server 122 to authenticate and thus obtain, for example, a decryption key. The one or more decryption keys may be used by the devices 104 to decrypt the encrypted content presented and/or broadcast from the presenter computing device over the Wi-Fi Direct® connection 106. Again, the systems 100 and 120 via, for example, the executable code 112 and 114 may provide for a software buffer 118 in memory 110 for storing of the presented or broadcast content during transmission and receipt.

FIG. 2 is a sequence diagram 200 for the system 120 of FIG. 1A and similar systems. The diagram 200 depicts wireless direct connection, authentication, the broadcast and receipt of meeting content post-authentication, and the decryption of the content. The multiple devices 104 may have a wireless direct connection 106 with the presenter device 102. The multiple computing devices 104 may authenticate 202 with a server 122. To do so, the computing devices 104 may couple and communicate with the server 102 via a conventional Wi-Fi connection 130 or other type of connection. For a computing device 104 to authenticate 202 with the server 122, a participant or user of a computing device 104 may provide a user name and password, for example. Upon or after authentication 202 of a computing device 104 with the server 122, the computing device 104 may obtain (as indicated by reference numeral 204) keys from the server 122 for decryption/encryption.

The presenter device 102 may broadcast 206 data or content (e.g., meeting content, presentations, etc.) to the multiple devices 104 via the wireless direct connection 106 (e.g., Wi-Fi Direct® or Wi-Fi Miracast™). The multiple receiving computing devices 104 and may be at relatively short range with the presenter computing device 102, such as in a meeting hall. The multiple computing devices 104 that have been authenticated 202 and thus obtained 204 the keys (e.g., encryption key), may use the keys to decrypt and render the broadcast content, as indicated by reference numeral 208. As mentioned, a software buffer 118 (see FIGS. 1A and 1B) may be configured and employed in the broadcast transmission of the data or content.

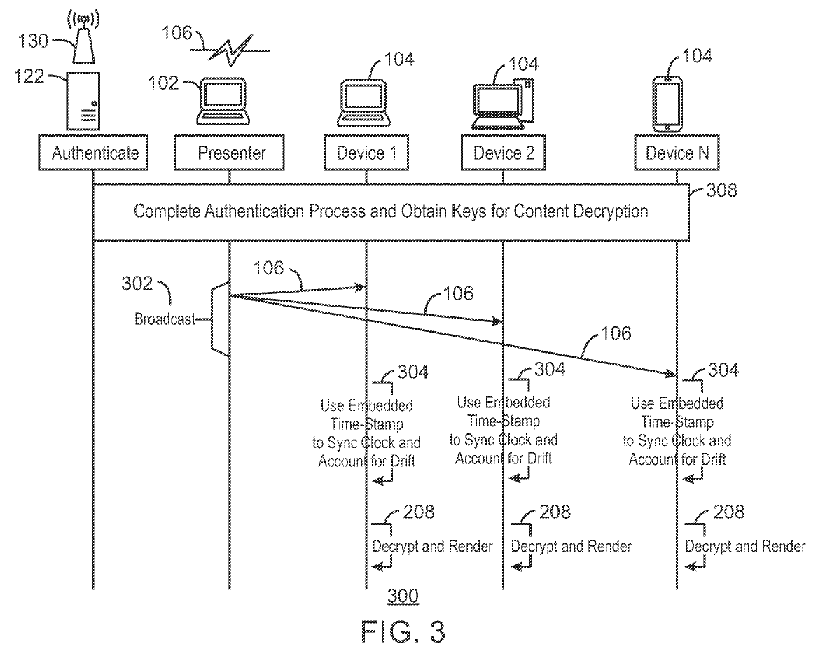

Certain embodiments may also provide for time-stamped audio-video (AV) broadcast for in-range devices. A presenter computing device may broadcast time-sensitive content as alluded, for instance, in example three mentioned above. The transmission in close proximity may facilitate sending of time-sensitive audio-video content given the low latency and high bandwidth (based on protocol selected). Some embodiments may provide that a presenter is to broadcast content over a channel via a wireless direct connection, and that audio and video packets are time-stamped. A receiver computing device in range may be able to tap into the broadcast after, for example, going through a security authentication process. The presenter may embed time-sync messages in packets for clock syncing and, in response, receiver computing devices may adjust their clocks and drift accordingly. After such adjustments, the receiver computing devices may be better prepared to view the broadcast content. FIG. 3 highlights examples of some of these features.

Because the time-sync information may be embedded in the broadcast packets, a receiver may generally join anytime in certain examples. Upon joining, the receivers (e.g., computing devices 104) may go through a process of syncing their clocks to account for the time drift and to stay in-sync with presenter (e.g., 102). The broadcast frames can be packaged as Moving Picture Experts Group transport stream (MPEG-TS) content that may be a standard container format for transmission of audio-video content. The time-stamping may be with respect to syncing of audio with video, and syncing of broadcast content between a presenter computing device 102 and a receiving computing device 104, and so on.

FIG. 3 is a sequence diagram 300 for the system 120 or similar system. As discussed, the receiving computing devices 104 may wirelessly direct connect 106 to the presenter computing device 102. Further, in the illustrated embodiment, the presenter computing device 102 may broadcast 302 time-stamped messages/frames to the computing devices 104 via the wireless direct connection 106. The code 112 executed by the presenter device processor 108 may provide for the presenter device 102 to time-stamp the messages/frames. The receiving computing devices 104 may use the embedded time-stamp to sync clock and account for drift, as indicated by reference numeral 304. Such may be performed, for example, via the code 114 executed by the receiving device processor 108.

However, in some examples, the computing devices 104 may first (or afterwards) wirelessly (AP) connect 130 to a server 122 for authentication to obtain keys for decryption, as discussed above and as indicated by the reference numeral 308 in FIG. 3. The computing devices 104 may decrypt and render the broadcast time-stamped content, as indicated by reference numeral 208. The syncing may be between audio and video, between the devices 102 and 104, and the like. The time-stamping and syncing may provide for a common clock source, a common network time, periodically transmitting and receiving a time sequence, and the like. Lastly, as mentioned, a software buffer 118 in memory 110 may hold the buffering of broadcast content time-stamp content during transmission and receipt.

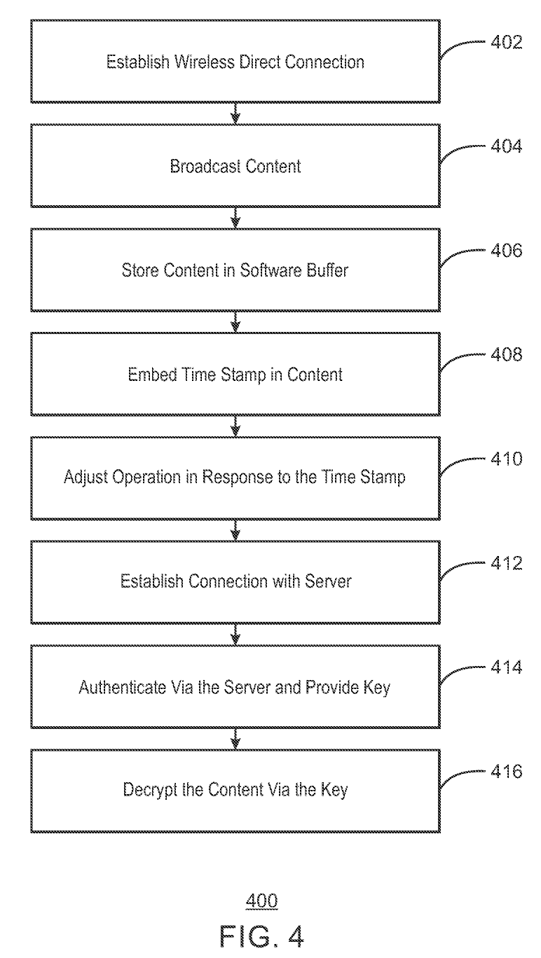

FIG. 4 is a method 400 of a personalized network. At block 402, the method includes establishing a wireless direct connection (e.g., Wi-Fi Direct®) between a presenter computing device and multiple receiving computing devices. At block 404, the method includes broadcasting content, via the wireless direct connection, from the presenter computing device to the multiple receiving computing devices. At block 406, the method includes storing the content in a software buffer during broadcast of the content. At block 408, the method includes embedding, via the presenter computing device, a time stamp in the content. At block 410, the method includes adjusting operation of the multiple receiving computing devices in response to the time stamp.

At block 414, the method includes establishing a connection (e.g., via a wireless access point or wired connection) between the multiple receiving computing devices and a server. At block 416, the method includes authenticating, via the server, the multiple receiving computing devices, and in response to the authentication, the server providing a key for decryption to multiple receiving computing devices. At block 418, the method includes the multiple receiving computing devices decrypting, via the key, the content received from the presenter computing device. Lastly, the blocks and their actions are not depicted in a particular order. For example, block 408 may be performed before block 404. Also, block 410 may be performed after block 416, and so on.

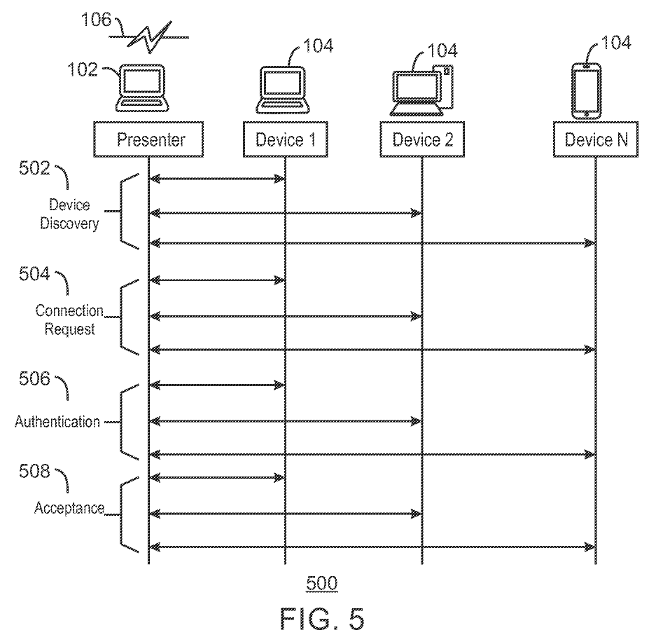

FIG. 5 is a sequence diagram 500 of a direct connection network or personalized network, including device connectivity setup in accordance with embodiments. In a peer-to-peer content sharing setup using a wireless direct connection, the listeners (stations) are all connected to the presenter. The buffer capacity of listeners could impact the bandwidth. Hence, stations may support 802.11n 3×3, or 802.11ac 1×1/2×2 for better results. Some of the actions involved to set up a peer-to-peer connection are shown in FIG. 5.

Device discovery 502 (e.g., via wireless, wireless direct, etc.) occurs between the presenter computing device 102 and the multiple receiving computing devices 104. A connection request 504 occurs between the presenter computing device 102 with the multiple receiving computing devices 104. A receiving computing device 104 may initiate the connection request 504 with the presenter computing device, and/or the presenter computing device 102 may initiate a connection request 504 with a receiving computing device 104. The connection request 504 may be for a wireless direct connection (e.g., Wi-Fi Direct®). The presenter computing device 102 may provide for authentication 506 of the multiple receiving computing devices 104 to give acceptance 508 of the multiple receiving computing devices 104 to the wireless direct connection with the presenter computing device 102. For authentication, a receiving computing device 104 may enter a code, for example. Moreover, a receiving computing device 104 may also require authentication 508 of the presenter computing device 102.

Once the connection is set up, a user of a presenter device 102 (and of a receiving device 104) may share content (presentation) directly over the direct wireless connection medium generally without the latency seen in a Wi-Fi (AP) connection setup. The underlying software stack may provide the interface that routes traffic through the wireless direct connection medium. Lastly, additional authentication of the multiple receiving computing devices 104 may be implemented at the presenter computing device 102 or at a server (not shown). Such authentication, as disused with respect to the previous figures, may relate to the provision of an encryption key to the multiple receiving computing devices 104, so that the devices 104 can decrypt content or data transferred, presented, or broadcast by the presenter computing device 102 over the wireless direct connection.

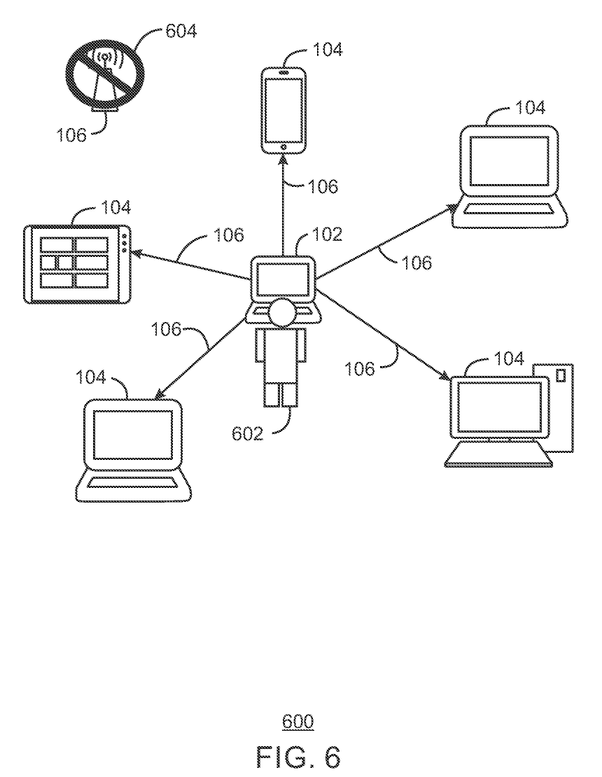

FIG. 6 is a system 600 of peer-to-peer content sharing. This new technology may localize content sharing and, therefore, improve performance and hence user experience. The system 600 may employ platform features such as peer-to-peer connectivity and content broadcast. The features may include encryption to be enabled that may facilitate the software to leverage the connectivity and broadcast, and provide a differentiated user experience. Once connections setup is complete, a user 602 may share content using P2P generally without the latency involved with Wi-Fi routing via an access point and a server(s). In the illustrated embodiment, the user 602 is of a presenter computing device 102 that may establish a wireless direct connection 106 with multiple receiving computing devices 104. The user 602 may share or broadcast content from the presenter computing device 102 to the multiple receiving computing devices 104. In this particular example, the wireless direct connection 106 does not involve Wi-Fi via an access point, as indicated by reference numeral 604. Of course, Wi-Fi (AP) and other protocols (e.g., wired, Ethernet, etc.) may be utilized in the system 600 or associated with the system 600.

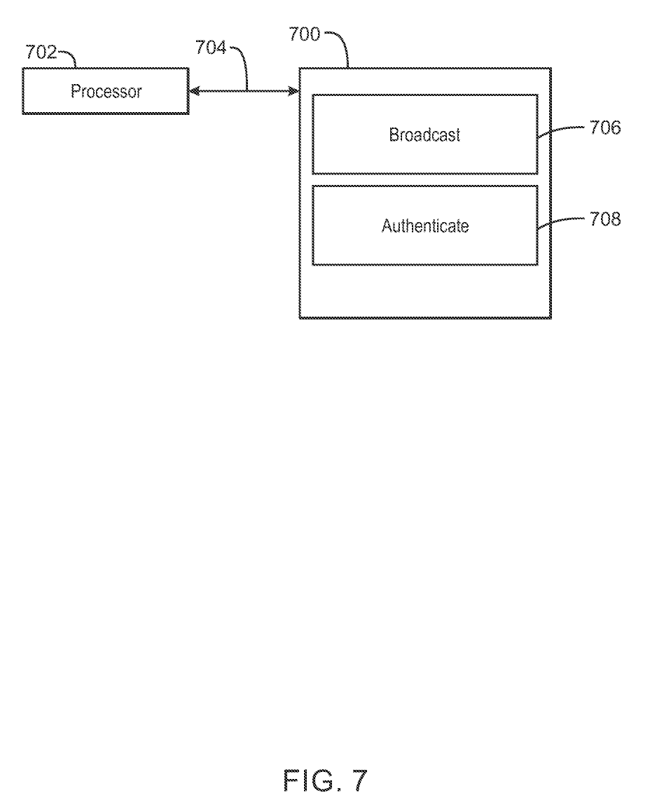

FIG. 7 is a block diagram depicting an example of a tangible non-transitory, computer-readable medium 700 that can facilitate establishing and operation of a wireless direct connection network (e.g., a personalized network), including the broadcast of content in the network. The computer-readable medium 700 may be accessed by a processor 702 over a computer interconnect 704. The processor 702 may be a processor (e.g., 108) of the network. The tangible, non-transitory, computer-readable medium 700 may include executable instructions or code to direct the processor 702 to perform the operations of the techniques described herein.

The various software components discussed herein may be stored on the tangible, non-transitory, computer-readable medium 702, as indicated in FIG. 7. For example, a broadcast module 706 may direct the processor 702 to facilitate establishing a wireless direct connection between devices, broadcasting content via the wireless direct connection, applying a time stamp to the content, adjusting operation of devices in response to the time stamp, storing content in a software buffer, providing an application interface for the broadcast, providing an underlying software stack and data layer, and so forth. In addition, an authentication module 708 may provide authentication of devices. In examples, the authentication may be performed via a server.

It should be understood that any number of additional software components not shown in FIG. 7 may be included within the tangible, non-transitory, computer-readable medium 700, depending on the application or other considerations. Moreover, while two modules 706 and 708 are depicted, additional modules directed to other applications and types of usages may be stored on medium 600.

In summary, an embodiment may include a broadcast system for a direct connection (e.g., personalized or Wi-Fi Direct®) network, including a presenter computing device configured for a wireless direct connection with multiple receiving computing devices, the presenter computing device to broadcast content via the wireless direct connection to the multiple receiving devices. Thus, the multiple receiving computing devices are configured for the wireless direct connection with the presenter computing device and to receive via the wireless direct connection the content broadcast by the presenter computing device. Furthermore, the presenter computing device may embed a time stamp in the content, and wherein the multiple computing devices may sync clock and account for drift in response to the time stamp. Additionally, a server computing device may further authenticate the multiple receiving devices. The multiple receiving computing devices may be configured to wirelessly connect via an access point or via direct W-Fi with the server computing device. One or more of the receiving devices may have a wired connection with the server in certain examples. Moreover, each receiving computing device may include memory having a software buffer to store the content during the broadcast of the content. Further, each receiving computing device may include memory having an application providing an interface for receiving the broadcast content. Additionally, the presenter computing device may encrypt the content broadcast to the multiple receiving computing devices. The server computing device may provide an encryption key to a receiving computing device in response to authentication of the receiving computing device by the server computing device. If so, the receiving computing device may decrypt and render via the encryption key the content broadcast by the presenter computing device and received by the receiving computing device.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment”, “one embodiment”, “some embodiments”, “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

Examples are given. Example 1 is a broadcast system for a direct connection network. The system includes: a presenter computing device configured for a wireless direct connection with multiple receiving computing devices and to broadcast content via the wireless direct connection to the multiple receiving devices; the multiple receiving computing devices configured for the wireless direct connection with the presenter computing device and to receive via the wireless direct connection the content broadcast by the presenter computing device; and a server computing device configured to authenticate the multiple receiving devices.

Example 2 includes the system of example 1, including or excluding optional features. In this example, each receiving computing device comprises memory having a software buffer to store the content during the broadcast of the content.

Example 3 includes the system of any one of examples 1 to 2, including or excluding optional features. In this example, each receiving computing device comprises memory having an application providing an interface for receiving the broadcast content.

Example 4 includes the system of any one of examples 1 to 3, including or excluding optional features. In this example, the wireless direct connection comprises Wi-Fi Direct®.

Example 5 includes the system of any one of examples 1 to 4, including or excluding optional features. In this example, the multiple receiving computing devices are configured to wirelessly connect via an access point with the server computing device.

Example 6 includes the system of any one of examples 1 to 5, including or excluding optional features. In this example, the presenter computing device is configured to encrypt the content broadcast to the multiple receiving computing devices, wherein the server computing device is configured to provide an encryption key to a receiving computing device of the multiple receiving computing devices in response to authentication of the receiving computing device by the server computing device, and wherein the receiving computing device is configured to decrypt and render via the encryption key the content broadcast by the presenter computing device and received by the receiving computing device.

Example 7 includes the system of any one of examples 1 to 6, including or excluding optional features. In this example, the presenter computing device is configured to embed a time stamp in the content, and wherein the multiple computing devices are configured to sync clock and account for drift in response to the time stamp.

Example 8 is a presenter computing device for a personalized network. The presenter computing device includes a processor, and network hardware to wirelessly direct connect with multiple receiving computing devices. The presenting computing device includes memory storing code executable by the processor to: wirelessly direct connect via the network hardware with the multiple receiving computing devices; broadcast content via wireless direct connections to the multiple receiving computing devices; and time-stamp the content such that the multiple computing devices may sync clock and account for drift.

Example 9 includes the computing device of example 8, including or excluding optional features. In this example, the code executable by the processor to provide, via the wireless direct connections, an application to the multiple receiving devices, the application providing an interface and a software buffer for the broadcast content, and wherein the wireless direct connections are not server-based.

Example 10 includes the computing device of any one of examples 8 to 9, including or excluding optional features. In this example, the wireless direct connections comprise Wi-Fi Direct®.

Example 11 includes the computing device of any one of examples 8 to 10, including or excluding optional features. In this example, the presenter computing device is configured to encrypt the content broadcast to the multiple receiving computing devices.

Example 12 is a method of a direct connection network. The method includes: establishing a wireless direct connection between a presenter computing device and multiple receiving computing devices; authenticating, via a server, the multiple receiving computing devices; broadcasting content, via the wireless direct connection, from the presenter computing device to the multiple receiving computing devices; embedding, via the presenter computing device, a time stamp in the content; and adjusting operation of the multiple computing devices in response to the time stamp.

Example 13 includes the method of example 12, including or excluding optional features. In this example, the method includes storing the content in a software buffer during broadcast of the content.

Example 14 includes the method of any one of examples 12 to 13, including or excluding optional features. In this example, the wireless direct connection comprises Wi-Fi Direct®.

Example 15 includes the method of any one of examples 12 to 14, including or excluding optional features. In this example, the method includes encrypting the content broadcast to the multiple receiving computing devices.

Example 16 includes the method of any one of examples 12 to 15, including or excluding optional features. In this example, the method includes wirelessly connecting, via an access point, the multiple receiving computing devices with the server to authenticate the multiple receiving computing devices.

Example 17 includes the method of any one of examples 12 to 16, including or excluding optional features. In this example, the method includes: providing a key for decryption from the server to the multiple receiving computing devices in response to authentication of the multiple receiving computing device by the server; and decrypting, via the key and the multiple receiving computing devices, the content broadcast from the presenter computing device.

Example 18 is a non-transitory, computer-readable medium. The computer-readable medium includes instructions that direct the processor to: establish a wireless direct connection between a presenter computing device and multiple receiving computing devices; broadcast content, via the wireless direct connection, from the presenter computing device to the multiple receiving computing devices; and embed, via the presenter computing device, a time stamp in the content.

Example 19 includes the computer-readable medium of example 18, including or excluding optional features. In this example, the instructions executable by a processor to store the content in a software buffer during the broadcast of the content.

Example 20 includes the computer-readable medium of any one of examples 18 to 19, including or excluding optional features. In this example, the wireless direct connection comprises Wi-Fi Direct®.

Example 21 includes the computer-readable medium of any one of examples 18 to 20, including or excluding optional features. In this example, the instructions executable by a processor to provide an application interface for receiving the content.

Example 22 includes the computer-readable medium of any one of examples 18 to 21, including or excluding optional features. In this example, the instructions executable by a processor to provide an underlying software stack for the broadcast and reception of the content.

Example 23 includes the computer-readable medium of any one of examples 18 to 22, including or excluding optional features. In this example, the instructions executable by a processor to adjust operation of the multiple computing devices in response to the time stamp.

Example 24 is a method for a direct connection network. The method includes: establishing a wireless direct connection between a presenter computing device and multiple receiving computing devices; broadcasting content, via the wireless direct connection, from the presenter computing device to the multiple receiving computing devices; and embedding, via the presenter computing device, a time stamp in the content.

Example 25 includes the method of example 24, including or excluding optional features. In this example, the method includes storing the content in a software buffer during the broadcast of the content.

Example 26 includes the method of any one of examples 24 to 25, including or excluding optional features. In this example, the wireless direct connection comprises Wi-Fi Direct®.

Example 27 includes the method of any one of examples 24 to 26, including or excluding optional features. In this example, the method includes providing an application interface for receiving the content. Optionally, the present computing device provides the application to the multiple receiving devices.

Example 28 includes the method of any one of examples 24 to 27, including or excluding optional features. In this example, the method includes provide an underlying software stack for the broadcast and reception of the content.

Example 29 includes the method of any one of examples 24 to 28, including or excluding optional features. In this example, the method includes adjusting operation of at least one of multiple computing devices in response to the time stamp.

Example 30 is a machine readable medium including code, when executed, to cause a machine to perform the method of any one of claims 24 to 29.

Example 31 is a direct connection network. The direct connection network includes: means for establishing a wireless direct connection between a presenter computing device and multiple receiving computing devices; means for authenticating the multiple receiving computing devices; means for broadcasting content, via the wireless direct connection, from the presenter computing device to the multiple receiving computing devices; means for embedding a time stamp in the content; and means for adjusting operation of the multiple computing devices in response to the time stamp.

Example 32 includes the direct connection network of example 31, including or excluding optional features. In this example, the direct connection network includes means for storing the content in a software buffer during broadcast of the content.

Example 33 includes the direct connection network of any one of examples 31 to 32, including or excluding optional features. In this example, the wireless direct connection comprises Wi-Fi Direct®.

Example 34 includes the direct connection network of any one of examples 31 to 33, including or excluding optional features. In this example, the direct connection network includes means for encrypting the content broadcast to the multiple receiving computing devices.

Example 35 includes the direct connection network of any one of examples 31 to 34, including or excluding optional features. In this example, the direct connection network includes means for connecting the multiple receiving computing devices with the server to authenticate the multiple receiving computing devices.

Example 36 includes the direct connection network of any one of examples 31 to 35, including or excluding optional features. In this example, the direct connection network includes: means for providing a key for decryption to the multiple receiving computing devices in response to authentication of the multiple receiving computing device; and means for decrypting the content broadcast from the presenter computing device.

Example 37 is a direct connection network. The direct connection network includes instructions includes: means for establishing a wireless direct connection between a presenter computing device and multiple receiving computing devices; means for broadcasting content, via the wireless direct connection, from the presenter computing device to the multiple receiving computing devices; and means for embedding, via the presenter computing device, a time stamp in the content.

Example 38 includes the direct connection network of example 37, including or excluding optional features. In this example, the direct connection network includes means for storing the content in a software buffer during the broadcast of the content.

Example 39 includes the direct connection network of any one of examples 37 to 38, including or excluding optional features. In this example, the wireless direct connection comprises Wi-Fi Direct®.

Example 40 includes the direct connection network of any one of examples 37 to 39, including or excluding optional features. In this example, the direct connection network includes means for providing an application interface for receiving the content. Optionally, the application is provided from the present computing device to the multiple receiving devices.

Example 41 includes the direct connection network of any one of examples 37 to 40, including or excluding optional features. In this example, the direct connection network includes means for providing an underlying software stack for the broadcast and reception of the content.

Example 42 includes the direct connection network of any one of examples 37 to 41, including or excluding optional features. In this example, the direct connection network includes means for adjusting operation of at least one of multiple computing devices in response to the time stamp.

Example 43 is a broadcast system for a direct connection network. The system includes: a presenter computing device configured for a wireless direct connection with multiple receiving computing devices and to broadcast content via the wireless direct connection to the multiple receiving devices; the multiple receiving computing devices configured for the wireless direct connection with the presenter computing device and to receive via the wireless direct connection the content broadcast by the presenter computing device; and a server computing device configured to authenticate the multiple receiving devices.

Example 44 includes the system of example 43, including or excluding optional features. In this example, each receiving computing device comprises memory having an application providing an interface for receiving the broadcast content, and wherein the memory having a software buffer to store the content during the broadcast of the content.

Example 45 includes the system of any one of examples 43 to 44, including or excluding optional features. In this example, the wireless direct connection comprises Wi-Fi Direct®, and wherein the multiple receiving computing devices are configured to wirelessly connect via an access point with the server computing device.

Example 46 includes the system of any one of examples 43 to 45, including or excluding optional features. In this example, the presenter computing device is configured to encrypt the content broadcast to the multiple receiving computing devices, wherein the server computing device is configured to provide an encryption key to a receiving computing device of the multiple receiving computing devices in response to authentication of the receiving computing device by the server computing device, and wherein the receiving computing device is configured to decrypt and render via the encryption key the content broadcast by the presenter computing device and received by the receiving computing device.

Example 47 includes the system of any one of examples 43 to 46, including or excluding optional features. In this example, the presenter computing device is configured to embed a time stamp in the content, and wherein the multiple computing devices are configured to sync clock and account for drift in response to the time stamp.

Example 48 is a presenter computing device for a personalized network. The presenter computing device includes a processor, and network hardware to wirelessly direct connect with multiple receiving computing devices. The memory stores code executable by the processor for the presenter computing device to: wirelessly direct connect via the network hardware with the multiple receiving computing devices; broadcast content via wireless direct connections to the multiple receiving computing devices; and time-stamp the content such that the multiple computing devices may sync clock and account for drift.

Example 49 includes the computing device of example 48, including or excluding optional features. In this example, the code executable by the processor for the presenter computing device to provide, via the wireless direct connections, an application to the multiple receiving devices, the application providing an interface and a software buffer for the broadcast content, and wherein the wireless direct connections are not server-based.

Example 50 includes the computing device of any one of examples 48 to 49, including or excluding optional features. In this example, the wireless direct connections comprise Wi-Fi Direct®, and wherein the presenter computing device is configured to encrypt the content broadcast to the multiple receiving computing devices.

Example 51 is a method of a direct connection network. The method includes: establishing a wireless direct connection between a presenter computing device and multiple receiving computing devices; authenticating, via a server, the multiple receiving computing devices. broadcasting content, via the wireless direct connection, from the presenter computing device to the multiple receiving computing devices; embedding, via the presenter computing device, a time stamp in the content; and adjusting operation of the multiple computing devices in response to the time stamp.

Example 52 includes the method of example 51, including or excluding optional features. In this example, the method includes: providing a key for decryption from the server to the multiple receiving computing devices in response to authentication of the multiple receiving computing device by the server; and decrypting, via the key and the multiple receiving computing devices, the content broadcast from the presenter computing device.

Example 53 includes the method of any one of examples 51 to 52, including or excluding optional features. In this example, the method includes: encrypting the content broadcast to the multiple receiving computing devices; storing the content in a software buffer during broadcast of the content; and wirelessly connecting, via an access point, the multiple receiving computing devices with the server to authenticate the multiple receiving computing devices.

Example 54 is a non-transitory, computer-readable medium. The computer-readable medium includes instructions that direct the processor to establish a wireless direct connection between a presenter computing device and multiple receiving computing devices; broadcast content, via the wireless direct connection, from the presenter computing device to the multiple receiving computing devices; and embed, via the presenter computing device, a time stamp in the content; and adjust operation of the multiple computing devices in response to the time stamp.

Example 55 includes the computer-readable medium of example 54, including or excluding optional features. In this example, the instructions executable by a processor to store the content in a software buffer during the broadcast of the content.

Example 56 includes the computer-readable medium of any one of examples 54 to 55, including or excluding optional features. In this example, the instructions executable by a processor to provide an application interface for receiving the content.

Example 57 includes the computer-readable medium of any one of examples 54 to 56, including or excluding optional features. In this example, the instructions executable by a processor to provide an underlying software stack for the broadcast and reception of the content.

Example 58 is a presenter computing device for a direct connection network. The presenter computing device includes a processor, and network interface hardware to wirelessly direct connect with multiple receiving computing devices. The presenter computing device has memory storing code executable by the processor to: wirelessly direct connect via the network interface hardware with the multiple receiving computing devices; broadcast content via wireless direct connections to the multiple receiving computing devices; encrypt the content broadcast to the multiple receiving computing devices; and time-stamp the content such that the multiple computing devices may sync clock and account for drift.

Example 59 includes the presenter computing device of example 58, including or excluding optional features. In this example, the code executable by the processor for the presenter computing device to provide, via the wireless direct connections, an application to the multiple receiving devices, the application providing an interface and a software buffer for the broadcast content, and wherein the wireless direct connections are not server-based.

Example 60 includes the presenter computing device of any one of examples 58 to 59, including or excluding optional features. In this example, the wireless direct connections comprise Wi-Fi Direct®.

Example 61 is a presenter computing device for broadcasting in a personalized network, the presenter computing device configured to: wirelessly direct connect via network interface hardware with the multiple receiving computing devices; broadcast content via wireless direct connections to the multiple receiving computing devices; and time-stamp the content such that the multiple computing devices may sync clock and account for drift.

Example 62 includes the presenter computing device of example 61, including or excluding optional features. In this example, the presenter computing device is configured to provide, via the wireless direct connections, an application to the multiple receiving devices, the application providing an interface and a software buffer for the broadcast content, and wherein the wireless direct connections are not server-based.

Example 63 includes the presenter computing device of any one of examples 61 to 62, including or excluding optional features. In this example, the wireless direct connections comprise Wi-Fi Direct®.

Example 63 includes the presenter computing device of any one of examples 61 to 63, including or excluding optional features. In this example, the presenter computing device is configured to encrypt the content broadcast to the multiple receiving computing devices.

It is to be understood that specifics in the aforementioned examples may be used anywhere in one or more embodiments. For instance, all optional features of the computing device described above may also be implemented with respect to either of the methods described herein or a computer-readable medium. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. A broadcast system for a direct connection network, comprising:
a presenter computing device configured for a wireless direct connection with multiple receiving computing devices and to broadcast content via the wireless direct connection to the multiple receiving computing devices;
the multiple receiving computing devices configured for the wireless direct connection with the presenter computing device and to receive via the wireless direct connection the content broadcast by the presenter computing device; and
a server computing device configured to authenticate the multiple receiving devices.

2. The broadcast system of claim 1, wherein each receiving computing device comprises memory having a software buffer to store the content during the broadcast of the content.

3. The broadcast system of claim 1, wherein each receiving computing device comprises memory having an application providing an interface for receiving the broadcast content.

4. The broadcast system of claim 1, wherein the wireless direct connection comprises Wi-Fi Direct®. The broadcast system of claim 1, wherein the multiple receiving computing devices are configured to wirelessly connect via an access point with the server computing device.

6. The broadcast system of claim 1, wherein the presenter computing device is configured to encrypt the content broadcast to the multiple receiving computing devices, wherein the server computing device is configured to provide an encryption key to a receiving computing device of the multiple receiving computing devices in response to authentication of the receiving computing device by the server computing device, and wherein the receiving computing device is configured to decrypt and render via the encryption key the content broadcast by the presenter computing device and received by the receiving computing device.

7. The broadcast system of claim 1, wherein the presenter computing device is configured to embed a time stamp in the content, and wherein the multiple computing devices are configured to sync clock and account for drift in response to the time stamp.

8. A presenter computing device for a personalized network, the presenter computing device comprising:
a processor;
network hardware to wirelessly direct connect with multiple receiving computing devices; and
memory storing code executable by the processor to:
wirelessly direct connect via the network hardware with the multiple receiving computing devices;
broadcast content via wireless direct connections to the multiple receiving computing devices; and
time-stamp the content such that the multiple computing devices may sync clock and account for drift.

9. The presenter computing device of claim 8, wherein the code executable by the processor to provide, via the wireless direct connections, an application to the multiple receiving devices, the application providing an interface and a software buffer for the broadcast content, and wherein the wireless direct connections are not server-based.

10. The presenter computing device of claim 8, wherein the wireless direct connections comprise Wi-Fi Direct®.

11. The presenter computing device of claim 8, wherein the presenter computing device is configured to encrypt the content broadcast to the multiple receiving computing devices.

12. A method of a direct connection network, comprising:
establishing a wireless direct connection between a presenter computing device and multiple receiving computing devices;
authenticating, via a server, the multiple receiving computing devices;
broadcasting content, via the wireless direct connection, from the presenter computing device to the multiple receiving computing devices;
embedding, via the presenter computing device, a time stamp in the content; and
adjusting operation of the multiple computing devices in response to the time stamp.

13. The method of claim 12, comprising storing the content in a software buffer during broadcast of the content.

14. The method of claim 12, wherein the wireless direct connection comprises Wi-Fi Direct®.

15. The method of claim 12, comprising encrypting the content broadcast to the multiple receiving computing devices.

16. The method of claim 12, comprising wirelessly connecting, via an access point, the multiple receiving computing devices with the server to authenticate the multiple receiving computing devices.

17. The method of claim 12, comprising:
providing a key for decryption from the server to the multiple receiving computing devices in response to authentication of the multiple receiving computing device by the server; and
decrypting, via the key and the multiple receiving computing devices, the content broadcast from the presenter computing device.

18. A non-transitory, computer-readable medium comprising instructions that, when executed by a processor, direct the processor to:
establish a wireless direct connection between a presenter computing device and multiple receiving computing devices;
broadcast content, via the wireless direct connection, from the presenter computing device to the multiple receiving computing devices; and
embed, via the presenter computing device, a time stamp in the content.

19. The non-transitory, computer-readable medium of claim 18, wherein the instructions executable by a processor to store the content in a software buffer during the broadcast of the content.

20. The non-transitory, computer-readable medium of claim 18, wherein the wireless direct connection comprises Wi-Fi Direct®.

21. The non-transitory, computer-readable medium of claim 18, wherein the instructions executable by a processor to provide an application interface for receiving the content.

22. The non-transitory, computer-readable medium of claim 18, wherein the instructions executable by a processor to provide an underlying software stack for the broadcast and reception of the content.

23. The non-transitory, computer-readable medium of claim 18, wherein the instructions executable by a processor to adjust operation of the multiple computing devices in response to the time stamp.
